(19) United States
(12) Patent Application Publication
(10) Pub. No.: US 2005/0126067 A1
(43) Pub. Date: Jun. 16, 2005

(54) Ultraviolet-reactive fishing line

(76) Inventor: Roger W. Lehmann, Brielle, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/732,016

(22) Filed: Dec. 10, 2003

(51) Int. Cl. A01K 91/00

(52) U.S. Cl. 43/44.98

(57) ABSTRACT

A fishing line that reacts to ultraviolet light so that during use the portion of the fishing line that is exposed to the ultraviolet rays of the sunlight provides a bright or colorful indicator to the user while that portion of the fishing line that is submerged, thereby blocking the ultraviolet rays of the sunlight, remains transparent or the fishing line's otherwise conventional clear appearance.

### BACKGROUND OF THE INVENTION

1. Field of Invention

This invention relates to fishing equipment and, more particularly, to fishing lines that react to ultraviolet light during use.

2. Description of Related Art

One of the problems experienced by fishermen is the need to see where the fishing line is during use while at the same time having the fishing line's appearance remain innocuous to the underwater sealife. In particular, although it is highly desirable for a fisherman to easily see his fishing line, specifically where and how it enters into the water, conversely it becomes undesirable for the fishing line to be visible after it enters into the water because then it can be seen by the fish and therefore frighten the fish away from the baited hook presented in the water.

One attempt at solving this problem has been to manufacture fishing line in clear and blue colors so that the fishing line effectively becomes “invisible” in the water. However, this method has been unsuccessful because it exaggerates the problem for the fisherman: the fishing line is also effectively rendered “difficult to see” to the fisherman because the fishing line is clear in color and therefore “difficult to see” to the naked eye, despite the blue colored portions.

Another attempt at improving the fisherman's ability to see the fishing line has been to manufacture fishing line in colors of high visibility such as yellow. However, this attempt has also proved unsuccessful because, as previously stated, these high visibility colored lines then become easily seen in the water by the fish and frighten the fish away from the baited hook presented in the water, thereby reducing the effectiveness of the fishing process.

The need to solve this problem becomes even more apparent in a method of fishing called “trolling” where the bait is attached to a hook and the hook, in turn, is attached to the fishing line that is being pulled by a slow-moving boat through the water. During trolling, a fishing line is extended great distances, sometimes up to ½ mile behind the moving boat, which alters its course by turns, course changes, etc, and therefore the fishing line's location and entry into the water becomes very difficult to see when using clear fishing line. The situation is further complicated when multiple fishing lines are pulled simultaneously behind the boat because care must be applied to make certain that the fishing lines don't cross over each other's path and become entangled.

Thus, there remains a need to solve this problem by having a fishing line whose portion that remains above the water be highly visible or detectable to the human eye while simultaneously the portion of the fishing line that is submerged be difficult to see to the sealife.

All references cited herein are incorporated herein by reference in their entireties.

### BRIEF SUMMARY OF THE INVENTION

A fishing line comprising an ultraviolet-reactive substance (e.g., integrated into the fishing line or forming a coating thereon) wherein the ultraviolet reactive substance turns a color (e.g., yellow) when exposed to the ultraviolet rays of sunlight and loses the color when the ultraviolet-reactive substance is no longer exposed to the ultraviolet rays of the sunlight.

A method of making a fishing line having an ultraviolet-reactive substance embedded therein. The method comprises the steps of: mixing the ultraviolet-reactive substance with a resin; and feeding the mixture through an extrusion process to form a monofilament having an integrated ultraviolet-reactive substance therein.

A method of making a fishing line having an ultraviolet-reactive substance embedded therein. The method comprises the step of feeding the ultraviolet-reactive substance and a resin into an extrusion process to form a monofilament having an integrated ultraviolet-reactive substance therein.

A method of making a fishing line having an ultraviolet-reactive substance. The method comprises the steps of: feeding a resin into an extrusion process to form a monofilament; and coating the monofilament with an ultraviolet-reactive substance.

### BRIEF DESCRIPTION OF SEVERAL VIEWS OF THE DRAWINGS

The invention will be described in conjunction with the following drawings in which like reference numerals designate like elements and wherein:

FIG. 1 is a partial side view of the fishing line of the present invention comprising an integrated ultraviolet-reactive substance that gives the fishing line a bright, highly visible color when exposed to the ultraviolet rays of the sunlight but which remains clear whenever the fishing line is not in the ultraviolet rays of direct sunlight;

FIG. 1A is a cross-sectional view of the present invention taken along line 1A-1A of FIG. 1;

FIG. 1B is a block diagram of an extrusion process for forming the present invention;

FIG. 1C is a block diagram of an alternative extrusion process for forming the present invention;

FIG. 2 is a functional diagram of the present invention being used during fishing and depicting how the portion of the present invention that is above the water remains highly visible or detectable by the fisherman whereas the portion of the present invention submerged in the water remains “difficult to see” to the sealife;

FIG. 3 is a partial side view of the fishing line of the present invention comprising an ultraviolet-reactive substance, applied as a coating on the fishing line, that gives the fishing line a bright, highly visible color when exposed to the ultraviolet rays of the sunlight but which remains clear whenever the fishing line is not in the ultraviolet rays of direct sunlight; and

FIG. 3A is a cross-sectional view of the present invention taken along line 3A-3A of FIG. 3.

### DETAILED DESCRIPTION OF THE INVENTION

The invention will be illustrated in more detail with reference to the following examples, but it should be understood that the present invention is not deemed to be limited thereto. The invention will be illustrated in more detail with reference to the following examples, but it should be understood that the present invention is not deemed to be limited thereto.

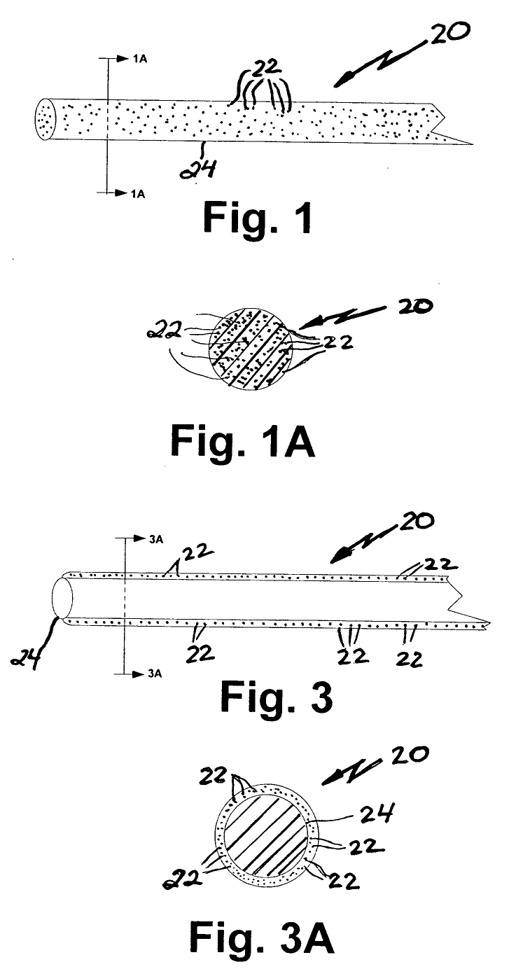

The present invention 20, as shown in FIG. 1, comprises a fishing line having an ultraviolet (UV)-reactive substance 22 integrated into the body 24 of the fishing line throughout.

Reversible color change materials are available in several chemical forms, such as inks and paints for surface coating and as chemicals that can be integrated directly into a product. The preferred embodiment of the present invention 20 comprises the ultraviolet (UV)-reactive substance 22 being integrated into the plastic resin of the fishing line during the fishing line manufacturing process to produce a reversible color change fishing line product. By integrating the UV-reactive substance 22 into the plastic resin of the fishing line, the changing color feature is more permanent by virtue of the fact that it is an integral part of the line 20 and not simply a surface coating that can wear, or possibly be scraped off or cracked when bent during constant use. In particular, the UV-reactive substance 22 is mixed with the resin (e.g., nylon, polyethylene, Dacron®, other nylon compounds, etc.) that is typically used in manufacturing fishing line which is then fed through an extrusion process (e.g., a plastic extrusion machine where a thermoplastic resin, mixed with said UV-reactive substance 22, is added in pellet size, heated and then through the action of pressure and heat, forced through a die to form a round filament), thereby yielding a monofilament fishing line containing the UV-reactive substance 22, as shown in FIGS. 1 and 1A. FIGS. 1B and 1C provide alternative methods of extruding the fishing line 20 having the integral UV-reactive substance 22 therein.

By way of example only, the following are inks, paints and additive materials that can be used as the UV-reactive substance 22 in the plastic resin of the fishing line: Photopia®Molding Materials, Photopia®Aqualite Ink, Photopia®Color Change Writer Base, Photopia®Aqualite Coloring System, Photopia®Color Paint, etc. all of which are manufactured and sold by Matsui International of Gardena, Calif. Alternatively, other similar UV-reactive substances 22 are available from The Pilot Ink, Co. LTD of Niagoya, Japan.

It should be understood that it is within the broadest scope of the invention to include the use of the integrated UV-reactive substance 22 in other forms of fishing line. For example, fluorocarbon fishing line, braided fishing line and weave fishing line. Braided fishing line comprises a plurality (e.g., two or three) of monofilaments are wound around each other; it is within the broadest scope of the present invention to include the use of the UV-reactive substance 22 in one or more of the filaments being used in the braided configuration.

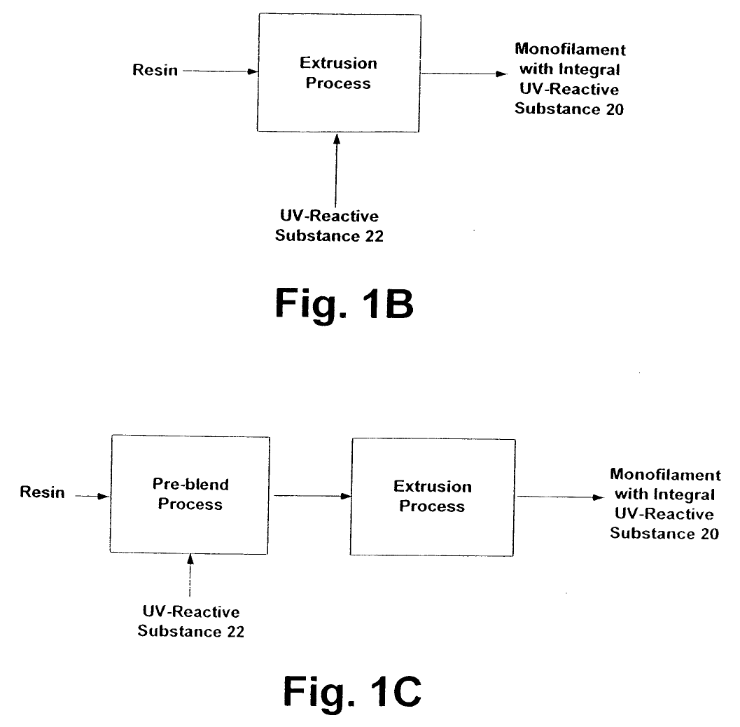

By way of example only, the present invention 20 may use a UV-reactive substance 22 that provides a yellow color when UV rays impact the fishing line 20. Thus, as shown in FIG. 2, when the fishing line of the present invention 20 is exposed to the UV rays of the sunlight 10, the portion 26 of the fishing line above the water 12 becomes highly visible (e.g., bright yellow in appearance) to the eye 16 of a fisherman; conversely, the submerged portion 28 of the fishing line 20 is no longer exposed to the UV rays of the sunlight 10 and hence the fishing line 20 takes on the conventional clear or transparent appearance. It should be noted that there is a transitional portion 25 of the fishing line 20, approximately two feet in depth (e.g., transitional depth 29) as measured from the surface 14 of the water 12, which is partially-exposed to the sunlight 10 and hence takes on a decreasingly duller yellow color until the two foot depth is reached wherein the fishing line 20 then takes on the conventional clear or transparent appearance.

Thus, the present invention 20 solves the fishing line visibility problem by having a fishing line that is both visible to the human eye 16 when out of the water while becoming “difficult to see” when in the water, by undergoing a change in color from a high visibility color (e.g., yellow) to clear and therefore effectively “invisible” to the fish in the water. As the fishing line 20 is retrieved from the water 12, the line 20 is again exposed to the sun's UV rays 10 and reverses its color back to a high visibility color (e.g., yellow).

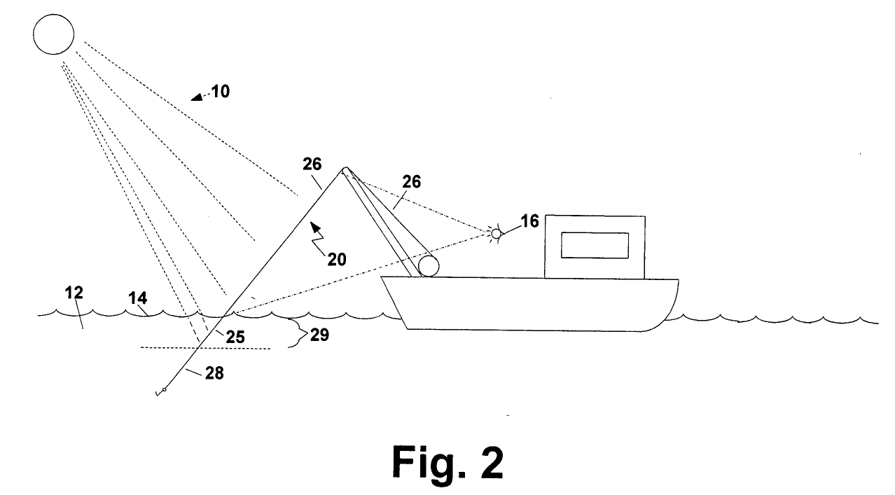

Although less preferred, it is within the broadest scope of the present invention 20 to include the UV-reactive substance 22 being applied as a coating to the outer surface of the body 24 fishing line 20; see FIGS. 3 and 3A. In this configuration, following the extrusion process, the fishing line 20 is then coated with the UV-reactive substance 22 (using any of the exemplary UV-reactive substances mentioned earlier); or, alternatively, the extrusion process can include the coating action as the filament emerges from the extrusion process. Moreover, it is within the broadest scope of the present invention to include the use of the coating UV-reactive substance 22 in other forms of fishing line such as fluorocarbon fishing line, braided fishing line and weave fishing line. Where the braided configuration is used, it is within the broadest scope of the present invention 20 to include at least one of the monofilaments comprises a coating of the UV-reactive substance 22.

While the invention has been described in detail and with reference to specific examples thereof, it will be apparent to one skilled in the art that various changes and modifications can be made therein without departing from the spirit and scope thereof.

1. (canceled)

2. (canceled)

3. A fishing line comprising an ultraviolet-reactive substance, said ultraviolet reactive substance turning a color when exposed to the ultraviolet rays of the sunlight and losing said color when said ultraviolet-reactive substance is no longer exposed to ultraviolet rays of the sunlight and said ultraviolet-reactive substance being integrated within the interior of the fishing line and wherein said fishing line comprises resin mixed with said ultraviolet-reactive substance, the combination of which is then extruded in an extrusion process to form a monofilament having said ultraviolet-reactive substance integrated therein.

4. The fishing line of claim 3 comprising a plurality of monofilaments formed into a braid and wherein at least one of said monofilaments comprises said ultraviolet reactive substance integrated within the interior of at least one of said monofilaments.

5. (canceled)

6. A fishing line comprising an ultraviolet-reactive substance, said ultraviolet reactive substance turning a color when exposed to the ultraviolet rays of the sunlight and losing said color when said ultraviolet-reactive substance is no longer exposed to ultraviolet rays of the sunlight, said ultraviolet-reactive substance being applied to an outside surface of said fishing line and wherein said fishing line comprises a plurality of monofilaments formed into a braid and wherein at least one of said monofilaments comprises said ultraviolet reactive substance coating on an outer surface of at least one of said monofilaments.

7. (canceled)

8. (canceled)

9. (canceled)
